(19) United States
(12) Patent Application Publication
(10) Pub. No.: US 2025/0282899 A1
(43) Pub. Date: Sep. 11, 2025

(54) NITRILE-CONTAINING PHOTOPOLYMERS

(71) Applicant: Lawrence Livermore National Security, LLC, Livermore, CA (US)

(72) Inventor: Benjamin Martin Alameda, Livermore, CA (US)

(21) Appl. No.: 18/596,203

(22) Filed: Mar. 5, 2024

(51) Int. Cl. C09D 133/20; B29C 64/124; B29C 64/30; B29C 71/02; B29K 33/00; B29K 33/18; B29K 33/20; B29K 105/00; B29L 31/34; B33Y 10/00; B33Y 40/20; B33Y 70/00; C01B 32/205; C08F 20/44; C08F 20/50; C09D 4/00; C09D 133/22

(52) U.S. Cl. CPC C08F 22/30

(57) ABSTRACT

A product, in accordance with one aspect of the present invention, includes a resin for three-dimensional printing, the resin including a photo-curable nitrile-containing photopolymer. A method for manufacturing an article of manufacture, in accordance with another aspect of the present invention, includes forming a three-dimensional (3D) structure from a photo-curable nitrile-containing photopolymer via a light-based printing process, and thermally processing the 3D structure for rendering the 3D structure electrically conductive.

This invention was made with Government support under Contract No. DE-AC52-07NA27344 awarded by the United States Department of Energy. The Government has certain rights in the invention.

### FIELD OF THE INVENTION

The present invention relates to photopolymerizable resins, and more particularly, this invention relates to nitrile-containing photopolymers usable, e.g., in resins for three-dimensional (3D) printing applications.

### BACKGROUND

Conductive organic materials such as graphite and graphene are of great interest in the production of energy storage devices and organic sensors due to their excellent electronic properties. Consequently, the demand for high performance electronic devices has furthered the need for conductive materials with complex architectures.

Additive manufacturing has helped enable the production of conductive matrices with architectures not achievable through conventional processing methods. However, there are several drawbacks to contemporary methods and materials, including the need for photopolymer composites with high percentages of carbon-based filler or conductive particles to achieve conductivity—a requirement that not only makes stereolithography (SLA) 3D printing difficult, but that is also prone to production of defects throughout the matrix due to poor dispersion. For example, conductive additives tend to make such resins opaque, thereby resulting in problems during photopolymerization, such as inadequate crosslinking. Moreover, the inherent inhomogeneity of the additives in the resins leads to formation of inclusions and inhomogeneous conductivity within the resulting structures.

Thus, existing processes are limited to extrusion-style printing such as direct ink writing (DIW).

Nitrile functional polyacrylonitrile (PAN) has been proven useful in the production of conductive carbon fibers due to its generally regular backbone, and ability to be graphitized in high yield via thermal processing. However, PAN is very difficult to process, and thus its commercial utility has heretofore been limited to solution-spun fibers and films. Moreover, conventional nitrile functional PANs are not electrically conductive, and are not photopolymerizable, so have not heretofore been used in light-based 3D printing.

What is needed is a way to enable production of graphitic carbon via additive manufacturing, in a way that avoids the drawbacks presented above.

### SUMMARY

A product, in accordance with one aspect of the present invention, includes a resin for three-dimensional printing, the resin including a photo-curable nitrile-containing photopolymer.

A method for manufacturing an article of manufacture, in accordance with another aspect of the present invention, includes forming a three-dimensional (3D) structure from a photo-curable nitrile-containing photopolymer via a light-based printing process, and thermally processing the 3D structure for rendering the 3D structure electrically conductive.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 depicts a method for manufacturing an article of manufacture, in accordance with various aspects of the present invention.

FIG. 2 depicts at least some components of a photo-curable nitrile-containing resin, in accordance with one embodiment.

FIG. 3 is a chart illustrating the photopolymerization kinetics of the illustrative formulation depicted in FIG. 2.

FIG. 4 depicts several five-layer-thick printed structures formed above a metal substrate using the exemplary resin of FIG. 2, and performed using a conventional PμSL apparatus.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

It is also noted that, as used in the specification and the appended claims, wt. % is defined as the percentage of weight of a particular component relative to the total weight/mass of the mixture. Vol. % is defined as the percentage of volume of a particular compound to the total volume of the mixture or compound. Mol. % is defined as the percentage of moles of a particular component to the total moles of the mixture or compound. Atomic % (at.%) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of a mixture, an ink, a printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The following description discloses various embodiments revolving around nitrile-containing photopolymers, including photo-curable nitrile-containing polymer resin formulations for production of nitrile-containing photopolymerized structures via additive manufacturing, including those useful for the production of electrically conductive graphitic materials. Also disclosed are methods for forming 3D printable resins having nitrile-containing photopolymer precursors. Methods of additive manufacturing are also presented. The presence of nitrile groups throughout the polymer architecture of the printed polymer product enables the chemical transformation into highly ordered graphitic domains via subsequent thermal processing.

In one general embodiment, a product includes a resin for three-dimensional printing, the resin including a photo-curable nitrile-containing photopolymer.

In another general embodiment, a method for manufacturing an article of manufacture includes forming a three-dimensional (3D) structure from a photo-curable nitrile-containing photopolymer via a light-based printing process, and thermally processing the 3D structure for rendering the 3D structure electrically conductive.

Some aspects of the present invention include nitrile-containing photopolymer resins that are capable of processing via additive manufacturing followed by graphitization via a thermally induced chemical transformation, thereby enabling formation of complex and fine-featured graphitic structures while circumventing the drawbacks of traditional polymer composite-based additive manufacturing, such as those based on resins with carbon filler.

Some aspects of the present invention include nitrile-containing photopolymers capable of light-based curing, e.g., ultraviolet (UV) curing, that enable production of articles of manufacture such as high-performance carbon electronics via 3D printing (e.g., using vat polymerization such as SLA or other technique) and subsequent thermal processing, thereby enabling a new paradigm of high-performance 3D printed electronics.

Advantages of the nitrile-containing photopolymerizable resins described herein include: (1) lack of expensive carbon-based fillers that can adversely affect light-based curing, and (2) the ability to form a more homogenous network microstructure, an attribute that enhances electronic performance, strength, and other favorable properties.

An additional advantage of nitrile-containing photopolymerizable resins described herein includes the ability to form structures at high resolution, with feature sizes much smaller than achievable using extrusion-based fabrication processes.

Various inventive concepts disclosed herein include a photopolymerizable polymer resin comprising one or more photoactive precursors and/or prepolymers that can be printed via a light-based printing process.

A product, in accordance with one aspect of the present invention, includes a resin having a photo-curable nitrile-containing photopolymer. In general, the photopolymer changes properties when exposed to light, such as UV light, and in some case visible light. The photopolymer may be a component of, or in the form of, a light-activated resin. Preferably, the photo-curable nitrile-containing photopolymer resin includes one or more types of nitrile-functional monomers and/or nitrile-containing polymers.

Nitrile-containing photopolymer resins, according to various approaches, may include one or more nitrile-functional components and/or one or more nitrile-containing polymers. Nitrile-functional components and nitrile-containing polymers are described in more detail below.

The particular combination of nitrile-functional component(s) and/or nitrile-containing polymer(s) in a resin may be selected to provide a desirable property to the resulting printed structure formed from the resin, such as a desirable network structure in the printed structure, e.g., to provide a substantially regular nitrile distribution in the network; strength; etc.

Nitrile-containing photopolymers, according to various approaches, may include one or more nitrile-functional components, such as: acrylonitrile-based monomer(s), cyanoacrylate-based monomer(s), acrylate-based monomer(s), and/or methacrylate-based monomer(s).

Nitrile-functional components having particular molecular compositions may be selected to impart particular properties on the resin, such as viscosity, extent of polymerization, hydrophobicity, etc. For example, a cyanoacrylate having a particular ester group may be selected over other cyanoacrylates to provide the desired properties, keeping in mind that a substantially regular distribution of nitrile groups in the resulting printed structure formed from the resin is desirable.

Moreover, photopolymers according to some approaches may include combinations of different types of the nitrile-functional components listed above, such as a combination of one or more acrylonitrile-based monomers with one or more acrylate-based monomers.

Exemplary acrylonitrile-based monomers include, but are not limited to: acrylonitriles amenable to photopolymerization such as: acrylonitrile or methacrylonitrile.

Exemplary cyanoacrylate-based monomers include alkyl cyanoacrylates amenable to photopolymerization, such as ethyl cyanoacrylate, butyl cyanoacrylate, etc.

Exemplary acrylate-based monomers include, but are not limited to: an acrylate-functional precursors (whether on a polyacrylate-based backbone or otherwise), multi-functional acrylate crosslinkers such as trimethylolpropane triacrylate or pentaerythritol tetraacrylate, acrylic acid, methyl acrylate, ethyl acrylate, butyl acrylate, 2-ethylhexyl acrylate, and cycloaliphatic or aromatic acrylates.

Exemplary methacrylate-based monomers include, but are not limited to: methacrylate precursors used in conventional vat-type printing, multi-functional methacrylate monomers, alkyl methacrylates, methacrylic acid, and cycloaliphatic or aromatic methacrylates.

Photo-curable nitrile-containing photopolymers, according to other approaches, may include one or more nitrile-containing polymers, such as polyacrylonitrile-based polymer(s) and/or polycyanoacrylate-based polymer(s).

Exemplary polyacrylonitrile-based polymers include, but are not limited to: dimers, trimers, oligomers, etc. that have N-functionalities that are compatible with the photopolymerization process. For example, the N-functionalities may be acrylate functionalities, methacrylate functionalities, etc. This includes linear and multiarm polymer architectures.

Exemplary polycyanoacrylate-based polymers include, but are not limited to: dimers, trimers, oligomers, etc. that have N-functionalities that are compatible with the photopolymerization process. For example, the N-functionalities may be acrylate functionalities, methacrylate functionalities, etc. This includes linear and multi-arm polymer architectures.

Nitrile-containing polymers having particular molecular compositions may be selected to impart particular properties on the resin, such as viscosity, extent of polymerization, hydrophobicity, etc. Again, a substantially regular distribution of nitrile groups in the printed structure is most desirable.

In one approach, the resin includes a prepolymer that is polyacrylonitrile-based, and that is N-functionalized with acrylate and/or methacrylate groups to function as the major backbone of the resulting polymer, and optionally to provide reactive diluence, e.g., to reduce viscosity.

In further approaches, the resin may have a combination of different nitrile-functional components present in particular ratios to provide a set of desired properties such as viscosity, transparency, etc. For example, a resin in accordance with one approach may have a copolymer system comprising two or more different copolymers, present in a ratio selected to provide a set of desirable properties. In general, similar considerations as are used in the carbon fiber production arts may be applied to select the relative ratios of materials.

A nitrile-containing polymer may be formed, in one approach, via living or controlled living polymerization following otherwise conventional techniques. For example, a nitrile-containing telechelic polymer may be formed in a process in which living chain ends initiated from a di, tri, or multifunctional initiator may be capped with a desired functionality.

A further approaches includes post polymerization modification, where chemical modification of an existing polymer structure is performed to add essential chemical handles that enable the material to initiate the photo polymerization reaction. For example, polyacrylonitrile itself is inert as a photopolymer, i.e., is not photopolymerizable; it is the addition of those chemical functionalities such as acrylates and/or methacrylates that allow them to be photopolymerized.

Photo-curable nitrile-containing photopolymers, according to further approaches, may include one or more nitrile-functional components, and one or more nitrile-containing polymers.

Ideally, upon creating the printed structure, the polymer backbone of the printed structure has a substantially regular distribution of nitrile groups therealong. Accordingly, when the printed structure is thermally processed for conversion thereof to a graphitic structure, the graphitic domains are fairly regular throughout the resulting conductive network.

A resin having the photopolymer may also include a photoinitiator that is compatible with the nitrile-functional component of the resin, multiple photoinitiators that are compatible with respective ones of the nitrile-functional components in a resin having multiple nitrile-functional components, etc. The photoinitiator may be a conventional photoinitiator. The photoinitiator is preferably present in an effective amount to provide a desired extent of polymerization (conversion). In some approaches, the photoinitiator system is present in a range of about 1 to about 7 wt % of a total weight of the resin.

Cyanoacrylate-based monomers or precursors do not polymerize well under radical conditions, and therefore an anionic or photo base initiation system is preferred. For acrylate or methacrylate-based monomers or precursors, traditional radical-generated initiation systems may be used. Selection of the proper photoinitiator and its concentration may be readily made by one skilled in the art after reading the present disclosure.

Other additives may be used in the resins, in effective amounts to provide a desired characteristic or result. Examples of such additives include a stabilizer, a transparent filler, a viscosity modifier, etc.

The resin is capable of light-based 3D printing into nitrile-containing polymer products that, in turn, can be thermally processed into a conductive, highly graphitic materials. To the inventor's knowledge, no attempt to 3D print nitrile-containing photopolymer resins has been attempted in the form of SLA or any other light-based processing method.

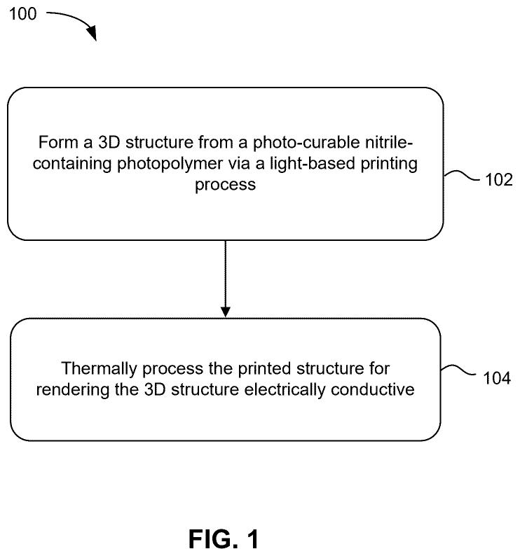

FIG. 1 depicts a method 100 for manufacturing an article of manufacture, in accordance with various aspects of the present invention. As an option, the present method 100 may be implemented to form materials and structures such as those described elsewhere herein and/or shown in the other FIGS. Of course, however, this method 100 and others presented herein are presented by way of example only. Further, the methods presented herein may be carried out in any desired environment. Moreover, more or less operations than those shown in FIG. 1 may be included in method 100, according to various embodiments. It should also be noted that any of the aforementioned features may be used in any of the embodiments described in accordance with the various methods.

In step 102, a 3D structure (or equivalently, a 2D structure) is formed from a photo-curable nitrile-containing photopolymer via a light-based printing process. The photopolymer may be, or be a component of, a resin.

Any light-based printing process may be used. For example, the resin may be processed via vat photopolymerization (VPP), such as SLA, digital light processing (DLP), projection micro stereolithography (PμSL), light-based volumetric additive manufacturing (VAM), and other 3D printing processes that rely on light. Conventional printing apparatuses may be used. Note also that the resin may be processed to print 2D structures, e.g., via stereolithography or the like, such 2D structures being deemed equivalent to the 3D structures noted herein.

Preferably, the printing process is performed in ambient conditions. Slight heating may be used to lower viscosity. Moreover, in approaches where the photo-curable nitrile-containing polymer resin is adversely affected by oxygen or the like, printing may occur in an inert atmosphere.

The intensity and wavelength of light may be selected to optimize the polymerization, in terms of extent of polymerization, rate of polymerization, etc., in a manner that would become apparent to one skilled in the art after reading the present disclosure.

The printed structure may be removed from the vat, and optionally rinsed.

In step 104, the printed structure is thermally processed for rendering the 3D structure electrically conductive. Preferably, the thermal processing converts the 3D structure to a graphitic structure.

A preferred thermal processing procedure includes submitting the printed structure to a temperature effective to convert the printed structure into a graphitic structure, ideally in an inert atmosphere. In one exemplary approach, the printed structure is placed in an inert atmosphere, e.g., in argon, nitrogen, etc., and the temperature is ramped up to the effective temperature for a duration sufficient to obtain the desired conversion. The final temperature endpoint may be around 1000° C., but could be higher or lower in various embodiments. Note also that the ramp rate may be adjusted to obtain the best outcome, in a manner that would be determinable by one skilled in the art after reading the present disclosure.

The thermally processed 3D structure may be a component such as a circuit, device, etc. for an electronic product such as a circuit board, sensor, energy storage device, etc. The method 100 may include manufacturing the electronic product.

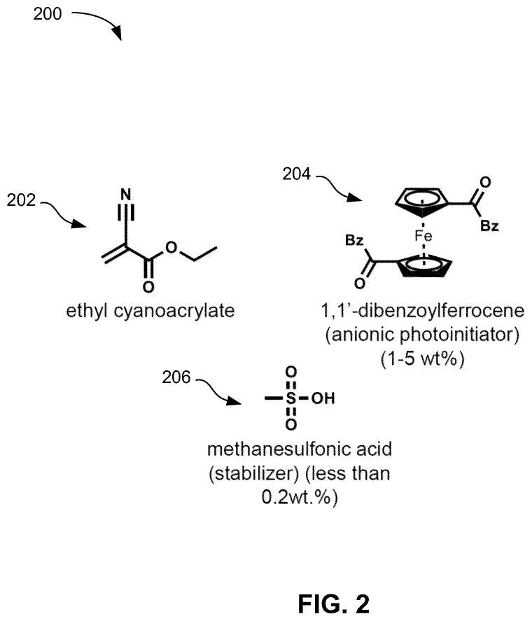

FIG. 2 depicts at least some components of a photo-curable nitrile-containing resin 200, in accordance with one embodiment. As an option, the present resin 200 may be implemented in conjunction with features from any other embodiment listed herein, such as those described with reference to the other FIGS. Of course, however, such a resin 200 and others presented herein may be used in various applications and/or in permutations which may or may not be specifically described in the illustrative embodiments listed herein. Further, the resin 200 presented herein may be used in any desired environment. Moreover, the resin 200 may have additional components added thereto.

As shown, one component is a cyanoacrylate monomer 202, which is the nitrile functional component of the resin 200. In this example, the cyanoacrylate monomer 202 is ethyl cyanoacrylate.

A photoinitiator 204 is present in the resin 200 at about 1 to about 5 wt % relative to the total weight of the resin. In this example, the photoinitiator 204 is 1,1′-dibenzoylferrocene, which is an anionic photoinitiator. Experimentation using a variety of radical and photobase initiators revealed that the ferrocene-based anionic initiator exhibited the best photopolymerization performance in terms of extent of polymerization. Moreover, radical initiators were found to provide a very low conversion, unless very high concentrations of initiator was present. However, high concentrations of initiator is not desirable as the initiator serves no function in the printed structure. Thus, it is more desirable to have higher concentrations of nitrile-containing component in a given resin.

All polymerizations performed in said experiments were performed in ambient conditions. Also, the photoinitiator and stabilizer were mixed prior to admixing with the cyanoacrylate.

In this example, an acidic stabilizer (methanesulfonic acid) 206 was also added at less than 0.2 wt % of the resin, because polymerization tends to occur for this system of cyanoacrylate monomer 202 and photoinitiator 204 in basic conditions and/or in the presence of moisture. Addition of the stabilizer extended the shelf life of the resin.

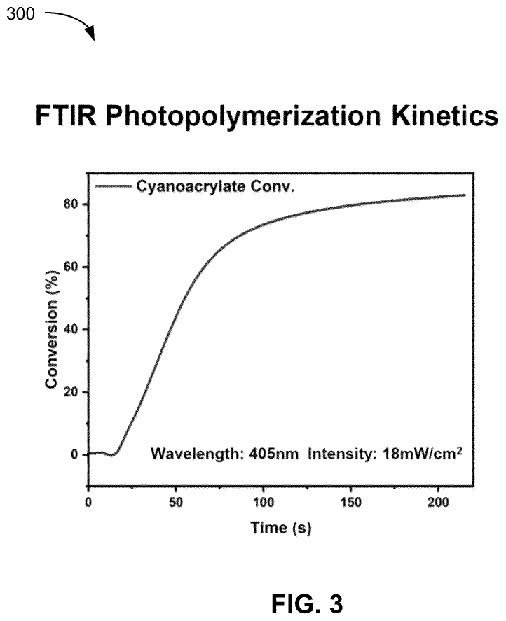

FIG. 3 is a chart 300 illustrating the photopolymerization kinetics of the illustrative formulation depicted in FIG. 2, as measured using real time Fourier-transform infrared spectroscopy (FTIR) to track the conversion of the cyanoacrylate functionality, using disappearance of the peak corresponding to that functionality to calculate the overall conversion. A high conversion is desirable to create the regular nitrile positioning in the printed structure, which in turn results in a better graphitic structure upon thermal processing.

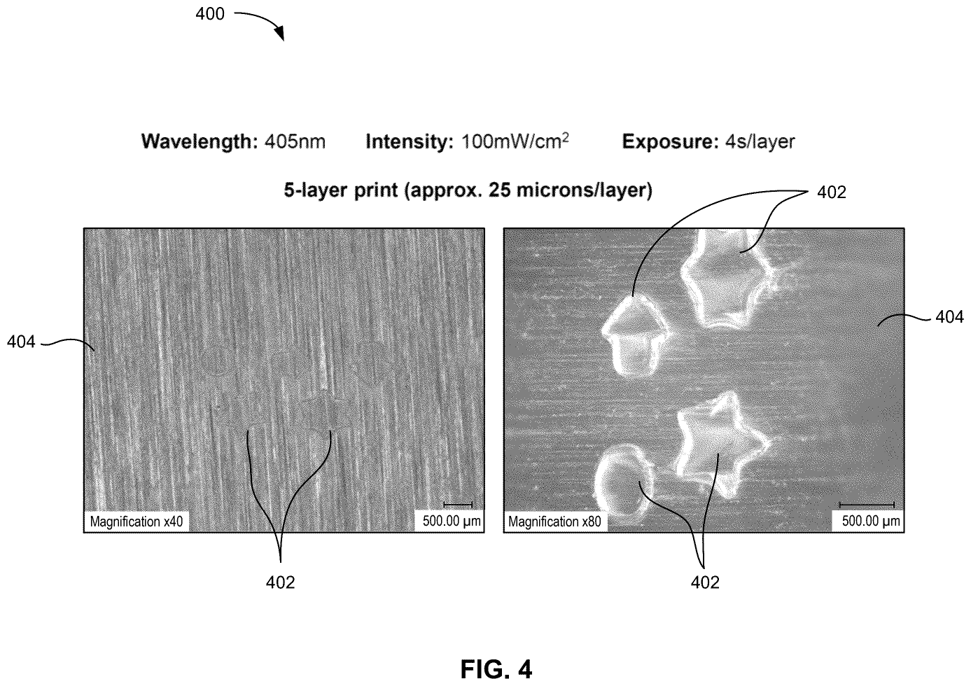

FIG. 4 includes depictions 400 of several five-layer-thick printed structures 402 formed above a metal substrate 404 using the exemplary resin of FIG. 2, and performed using a conventional PμSL apparatus. Each layer was approximately 25 microns thick. The wavelength of light used was 405 nm at an intensity of 100 mW/cm². The exposure time was 4 seconds per layer. The structures are demonstrative of the finer resolution attainable using various aspects of the present invention, especially relative to other types of additive manufacturing such as extrusion-based printing.

In Use:

The graphitic structures created according to the teachings herein may be used in any application where a conductive structure is desired, especially conductive structures derived in part from printing. The ability to form such structures via, in part, printing allows fabrication of well-defined features as well as smaller feature sizes than has heretofore been possible via additive manufacturing.

Exemplary uses of the photopolymers and resins presented herein include use in printable electronics fabrication. For example, various embodiments enable the fabrication of printed electronic products with well-defined architectures and/or complex architectures.

Exemplary articles of manufacture that may be created using the photopolymers and resins described herein include energy storage devices, organic sensors, flexible circuits, flexible circuit boards, etc.

Additional uses include fabrication of materials and/or components for energy storage such as battery electrodes, organic sensors, and carbon-based polymer composites.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept but should be defined only in accordance with the following claims and their equivalents.

What is claimed is:

1. A product, comprising:
a resin for three-dimensional printing, the resin including a photo-curable nitrile-containing photopolymer.

2. The product as recited in claim 1, wherein the photopolymer includes an acrylonitrile-based monomer.

3. The product as recited in claim 1, wherein the photopolymer includes a cyanoacrylate-based monomer.

4. The product as recited in claim 1, wherein the photopolymer includes an acrylate-based monomer.

5. The product as recited in claim 1, wherein the photopolymer includes a methacrylate-based monomer.

6. The product as recited in claim 1, wherein the photopolymer includes a polyacrylonitrile-based polymer.

7. The product as recited in claim 1, wherein the photopolymer includes a polycyanoacrylate-based polymer.

8. The product as recited in claim 1, wherein the photopolymer includes at least one nitrile-functional component selected from the group consisting of: an acrylonitrile-based monomer, a cyanoacrylate-based monomer, an acrylate-based monomer, and a methacrylate-based monomer; and at least one nitrile-containing polymer selected from the group consisting of: a polyacrylonitrile-based polymer and a polycyanoacrylate-based polymer.

9. The product as recited in claim 1, wherein the resin is configured for vat photopolymerization into three-dimensional objects.

10. The product as recited in claim 1, further comprising a photoinitiator present in an effective amount to provide a desired extent of polymerization.

11. A method for manufacturing an article of manufacture, the method comprising:
forming a three-dimensional (3D) structure from a photo-curable nitrile-containing photopolymer via a light-based printing process; and
thermally processing the 3D structure for rendering the 3D structure electrically conductive.

12. The method as recited in claim 11, wherein the light-based printing process is a vat photopolymerization (VPP) process.

13. The method as recited in claim 12, wherein the VPP process includes stereolithography (SLA).

14. The method as recited in claim 12, wherein the VPP process includes digital light processing (DLP).

15. The method as recited in claim 12, wherein the VPP process includes projection micro stereolithography (PμSL).

16. The method as recited in claim 11, wherein the photopolymer includes at least one nitrile-functional component selected from the group consisting of: an acrylonitrile-based monomer, a cyanoacrylate-based monomer, an acrylate-based monomer, and a methacrylate-based monomer.

17. The method as recited in claim 11, wherein the photopolymer includes at least one nitrile-functional component selected from the group consisting of: a polyacrylonitrile-based polymer and a polycyanoacrylate-based polymer.

18. The method as recited in claim 11, wherein the thermally processed 3D structure is a component for an electronic product.

19. The method as recited in claim 18, comprising manufacturing the electronic product.

20. The method as recited in claim 11, wherein the thermal processing converts the 3D structure to a graphitic structure.
